(19) United States
(12) Patent Application Publication
(10) Pub. No.: US 2026/0162081 A1
(43) Pub. Date: Jun. 11, 2026

(54) Curated Communication System and Method

(71) Applicant: MAVRIK Technologies LLC, Charlotte, NC (US)

(72) Inventor: Maxwell Holloway Owens, Charlotte, NC (US)

(21) Appl. No.: 19/221,160

(22) Filed: May 28, 2025

Related U.S. Application Data
(60) Provisional application No. 63/653,126, filed on May 29, 2024.

(51) Int. Cl. G06Q 10/42

(52) U.S. Cl. CPC G06Q 10/42

(57) ABSTRACT

A method, computer program product, and computing system for processing a social network of connections between a plurality of users. A candidate pair of users with a common second level connection is generated, wherein the candidate pair of users includes a first user and a respective second user. A request packet from a first computing device associated with the first user including a request for the common second level connection to enable a direct electronic communication between the first computing device and a computing device associated with the respective second user is processed. The request packet is provided to a computing device associated with the common second level connection. The direct electronic communication between the first computing device and the computing device associated with the respective second user is selectively enabled in response to processing the request packet at the computing device associated with the common second level connection.

### RELATED APPLICATION

This application claims the benefit of U.S. Provisional Application No. 63/653,126, filed on 29 May 2024, the entire contents of which are herein incorporated by reference.

### BACKGROUND

Many social networking platforms allow users to form connections based on personal, familial, professional, or other social characteristics. These platforms typically provide an electronic profile representative of a particular user that is discoverable within the platform for others to establish a connection. However, such profiles may be inaccurate, incomplete, or categorically false. Additionally, different methods for allowing users to interact within these platforms may leave users vulnerable to deception, misinformation, and, in extreme situations, predatory behavior. Accordingly, conventional approaches to managing electronic communications between users within a social networking environment are unable to provide sufficient security and transparency to protect users during electronic communications with others.

### SUMMARY OF DISCLOSURE

In one example implementation, a computer-implemented method executed on a computing device may include, but is not limited to, processing a social network of connections between a plurality of users, wherein the social network of connections includes a plurality of first level connections and a plurality of second level connections between the plurality of users. A candidate pair of users with a common second level connection is generated, wherein the candidate pair of users includes a first user and a respective second user. A request packet from a first computing device associated with the first user including a request for the common second level connection to enable a direct electronic communication between the first computing device associated with the first user and a computing device associated with the respective second user is processed. The request packet is provided to a computing device associated with the common second level connection. The direct electronic communication between the first computing device and the computing device associated with the respective second user is selectively enabled in response to processing the request packet at the computing device associated with the common second level connection.

One or more of the following example features may be included. A profile for the first user may be generated within the social network of connections. Generating the candidate pair of users may include prompting the common second level connection to select the respective second user. Generating the candidate pair of users may include providing an indication of the respective second user and the common second level connection to the first computing device associated with the first user. Selectively enabling the direct electronic communication may include enabling the direct electronic communication in response to receiving a direct electronic communication enablement packet from the computing device associated with the common second level connection that is configured to enable to the direct electronic communication between the first computing device associated with the first user and the computing device associated with the respective second user. The direct electronic communication between the first computing device associated with the first user, the computing device associated with the respective second user, and the computing device associated with the common second level connection may be established. Selectively enabling the direct electronic communication may include preventing the direct electronic communication in response to receiving a direct electronic communication rejection packet from the computing device associated with the common second level connection that is configured to prevent the direct electronic communication between the first computing device and the computing device associated with the respective second user.

In another example implementation, a computer program product resides on a computer readable medium that has a plurality of instructions stored on it. When executed by a processor, the instructions cause the processor to perform operations that may include, but are not limited to, processing a social network of connections between a plurality of users, wherein the social network of connections includes a plurality of first level connections and a plurality of second level connections between the plurality of users. A candidate pair of users with a common second level connection is generated, wherein the candidate pair of users includes a first user and a respective second user. A request packet from a first computing device associated with the first user including a request for the common second level connection to enable a direct electronic communication between the first computing device associated with the first user and a computing device associated with the respective second user is processed. The request packet is provided to a computing device associated with the common second level connection. The direct electronic communication between the first computing device and the computing device associated with the respective second user is selectively enabled in response to processing the request packet at the computing device associated with the common second level connection.

One or more of the following example features may be included. A profile for the first user may be generated within the social network of connections. Generating the candidate pair of users may include prompting the common second level connection to select the respective second user. Generating the candidate pair of users may include providing an indication of the respective second user and the common second level connection to the first computing device associated with the first user. Selectively enabling the direct electronic communication may include enabling the direct electronic communication in response to receiving a direct electronic communication enablement packet from the computing device associated with the common second level connection that is configured to enable to the direct electronic communication between the first computing device associated with the first user and the computing device associated with the respective second user. The direct electronic communication between the first computing device associated with the first user, the computing device associated with the respective second user, and the computing device associated with the common second level connection may be established. Selectively enabling the direct electronic communication may include preventing the direct electronic communication in response to receiving a direct electronic communication rejection packet from the computing device associated with the common second level connection that is configured to prevent the direct electronic communication between the first computing device and the computing device associated with the respective second user.

In another example implementation, a computing system includes at least one processor and at least one memory architecture coupled with the at least one processor, wherein the at least one processor is configured to process a social network of connections between a plurality of users, wherein the social network of connections includes a plurality of first level connections and a plurality of second level connections between the plurality of users. A candidate pair of users with a common second level connection is generated, wherein the candidate pair of users includes a first user and a respective second user. A request packet from a first computing device associated with the first user including a request for the common second level connection to enable a direct electronic communication between the first computing device associated with the first user and a computing device associated with the respective second user is processed. The request packet is provided to a computing device associated with the common second level connection. The direct electronic communication between the first computing device and the computing device associated with the respective second user is selectively enabled in response to processing the request packet at the computing device associated with the common second level connection.

One or more of the following example features may be included. A profile for the first user may be generated within the social network of connections. Generating the candidate pair of users may include prompting the common second level connection to select the respective second user. Generating the candidate pair of users may include providing an indication of the respective second user and the common second level connection to the first computing device associated with the first user. Selectively enabling the direct electronic communication may include enabling the direct electronic communication in response to receiving a direct electronic communication enablement packet from the computing device associated with the common second level connection that is configured to enable to the direct electronic communication between the first computing device associated with the first user and the computing device associated with the respective second user. The direct electronic communication between the first computing device associated with the first user, the computing device associated with the respective second user, and the computing device associated with the common second level connection may be established. Selectively enabling the direct electronic communication may include preventing the direct electronic communication in response to receiving a direct electronic communication rejection packet from the computing device associated with the common second level connection that is configured to prevent the direct electronic communication between the first computing device and the computing device associated with the respective second user.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a communication process coupled to a distributed computing network according to one or more example implementations of the disclosure;

FIG. 2 is an example flowchart of the communication process of FIG. 1 according to one or more example implementations of the disclosure;

FIG. 3 is an example diagrammatic view of a social network according to one or more example implementations of the disclosure; and

FIGS. 4-6 are example diagrammatic views of the communication process of FIG. 1 according to various example implementations of the disclosure.

Like reference symbols in the various drawings indicate like elements.

### DETAILED DESCRIPTION

### System Overview

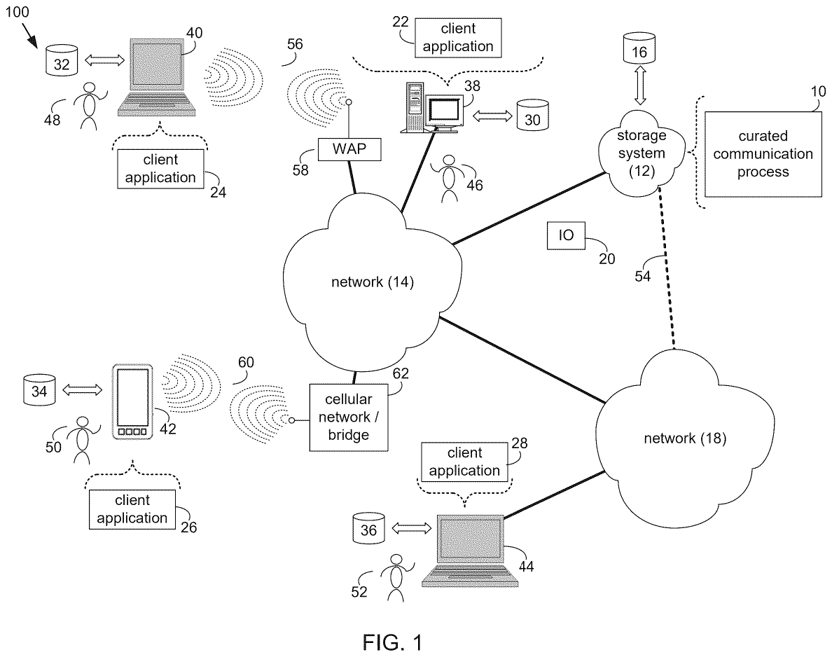

Referring to FIG. 1, there is shown communication process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a minicomputer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of communication process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of communication process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g., IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, an communication process, such as communication process 10 of FIG. 1, may include but is not limited to, processing a social network of connections between a plurality of users, wherein the social network of connections includes a plurality of first level connections and a plurality of second level connections between the plurality of users. A candidate pair of users with a common second level connection is generated, wherein the candidate pair of users includes a first user and a respective second user. A request packet from a first computing device associated with a first user including a request for the common second level connection to enable the direct electronic communication between the first computing device and the computing device associated with the respective second user is processed. The request packet is provided to a computing device associated with the common second level connection. The direct electronic communication between the first computing device and the computing device associated with the respective second user is selectively enabled in response to processing the request packet at the computing device associated with the common second level connection.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Curated Communication Process

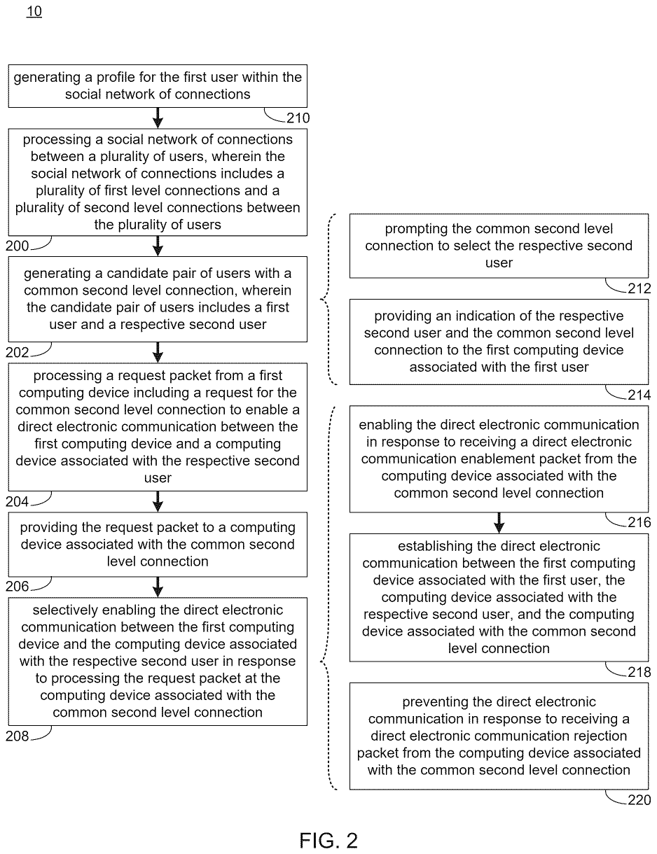

Referring also to FIGS. 2-6 and in some implementations, communication process 10 processes 200 a social network of connections between a plurality of users, wherein the social network of connections includes a plurality of first level connections and a plurality of second level connections between the plurality of users. A candidate pair of users with a common second level connection is generated 202, wherein the candidate pair of users includes a first user and a respective second user. A request packet from a first computing device associated with the first user including a request for the common second level connection to enable a direct electronic communication between the first computing device associated with the first user and a computing device associated with the respective second user is processed 204. The request packet is provided 206 to a computing device associated with the common second level connection. The direct electronic communication between the first computing device and the computing device associated with the respective second user is selectively enabled 208 in response to processing the request packet at the computing device associated with the common second level connection.

For example and as discussed above, many social networking platforms allow users to form connections based on personal, familial, professional, or other social characteristics. These platforms typically provide an electronic profile representative of a particular user that is discoverable within the platform for others to establish a connection. However, such profiles may be inaccurate, incomplete, or categorically false. Additionally, different methods for allowing users to interact within these platforms may leave users vulnerable to deception, misinformation, and, in extreme situations, predatory behavior. Accordingly, conventional approaches to managing electronic communications between users within a social networking environment are unable to provide sufficient security and transparency to protect users during electronic communications with others.

Implementations of the present disclosure allow for electronic communication between users of a social network to be selectively enabled by interfacing with a common connection between each user. For example, communication process 10 provides the ability for a common connection to help electronically connect users. For instance, users are much more likely to have successful connections with other users when the common connection uses their credibility and the trust of the respective users to facilitate a connection. However, beyond simply establishing a common connection, communication process 10 allows the common connection to selectively enable communications between users. In this manner, the safety and transparency of social networking is improved. In another example, connections are more likely to be successful when they have a meaningful relationship with the same individual, meaning they likely share similar interests, mannerisms, political views, etc. Further, communication process 10 removes the predatory and random nature that exist in social networks because rather than blindly or deceptively representing individuals, a candidate pair of users is linked by a common connection. In another example, communication process 10 removes the risk from false or “bot” accounts because social network connections within communication process 10 are built through known contacts. As such, users can be certain that the profiles and candidate pairings are associated with real people.

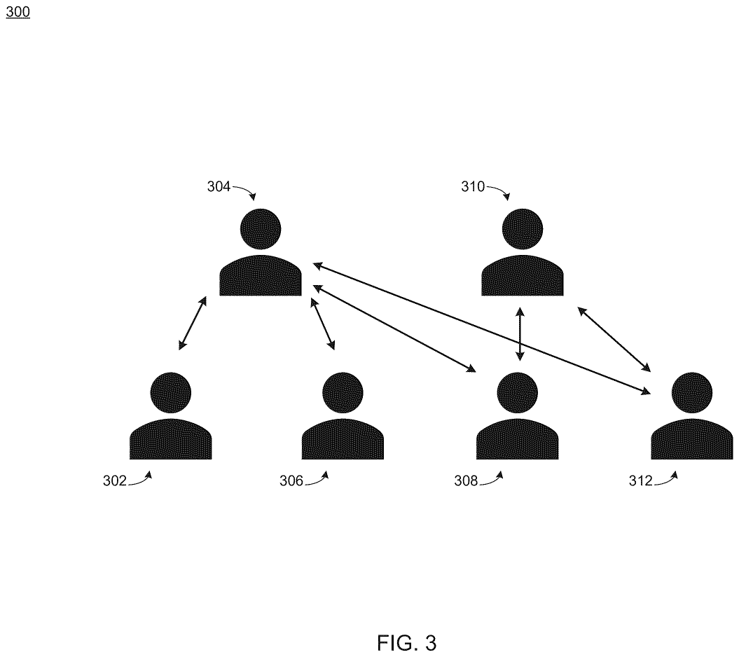

In some implementations, communication process 10 processes 200 a social network of connections between a plurality of users, wherein the social network of connections includes a plurality of first level connections and a plurality of second level connections between the plurality of users. For example and referring also to FIG. 3, a social network of connections (e.g., social network 300) is shown between e.g., six users (e.g., users 302, 304, 306, 308, 310, 312). For example, users 302 and 304 have a direct connection (i.e., they have connected profiles within social network 300) and users 304 and 306 have a direct connection. In this example, users 302 and 304 have a first level connection or direct connection and users 304 and 306 have a first level connection or direct connection. As users 302 and 306 have a common connection through their connection to user 304, users 302 and 306 have a second level connection or indirect connection through user 304 (e.g., common second level connection). Similarly, users 308 and 312 each have a respective first level connection or direct connection with users 304 and user 310. In this example, users 308 and 312 have a second level connection or indirect connection through user 310. In this manner, users with different levels of connection (i.e., first or second) can be defined by social network 300.

In some implementations, communication process 10 generates 210 a profile for the first user within the social network of connections. For example, as a precursor to processing 200 social network 300 for a given user, communication process 10 generates 210 a profile for the user by providing a user interface with text and multimedia fields for content associated with the user (e.g., photograph of the user, a summary or biography of the user, age, gender, location, interests, relationship preferences or goals for social network 300, etc.).

In some implementations, generating 210 the profile for a user includes prompting a user to complete a compatibility assessment during profile creation, answering questions about values, interests, lifestyle, relationship goals, etc. (e.g., “Do you prefer staying in or going out?” or “How important is family to you?”). As will be discussed in greater detail below, communication process 10 uses these responses to generate a compatibility score between two potential users when generating candidate pairs that a common second level connection can access to assist when selectively enabling communication between users. In one example, an assessment is added to the profile generation process including a number of questions (e.g., 10 to 15 questions) with multiple-choice or scale-based answers.

In some implementations, generating 210 the profile includes prompting the user to provide information concerning their connections. In one example, communication process 10 prompts each user to add friends, colleagues, or family through their contacts or electronic applications. For instance, communication process 10 may provide a text-based link or reference that can be shared with other users. In another example, communication process 10 may import contacts from external databases to generate template invitations for joining the social network. For example, communication process 10 may import and map information from particular text and multimedia content fields of a database (e.g., a contacts database, a friend list of a social network application, etc.) to potential profile information and invitations to respective contacts of the user. In some implementations, communication process 10 may normalize nomenclature or references to particular text and multimedia content from one source to a standardized form for processing by communication process 10. In this example, communication process 10 may use an ontological resource/reference from communication process 10 or external to communication process 10 to normalize text and multimedia content to a formatting ingestible by communication process 10.

In some implementations and to further ensure the authenticity of connections and to add an engaging element to building the social network, users can add others through a trivia-based request system. For instance, to send a request, the user answers a set of trivia questions about the person they wish to add (e.g., their favorite hobby, hometown, or a shared memory). Correct answers verify the connection and allow the request to be sent, enhancing the trust-based nature of the social network and verifying genuine connections.

In some implementations, communication process 10 generates 202 a candidate pair of users with a common second level connection, wherein the candidate pair of users includes a first user and a respective second user. For example, following the generation of a user's profile, communication process 10 provides options for generating a candidate pairing between the user and another user within the social network (e.g., social network 300). In one example, social network 300 may provide a listing of professional skills that can be queried. In another example, social network 300 provides a listing of users and generates candidate pairs for potential relationships between users (e.g., mentor relationships, friendships, hobby groups, dating opportunities, etc.). As will be discussed in greater detail below and in contrast to conventional approaches to identifying connections between individuals based on traits or characteristics of each person, communication process 10 generates 202 candidate pairs with the primary constraint of a common second level connection.

For example, communication process 10 generates 202 the candidate pair of users by first identifying each potential pairing of users that have a common or mutual second level connection. Referring again to the example of FIG. 3, communication process 10 identifies users 302 and 306; users 302 and 308; users 302 and 312 as potential pairings because of their common second level connection through user 304. Similarly, communication process 10 identifies users 308 and 312 as a potential pairing because of their common second level connection through user 310. In some implementations, communication process 10 uses the plurality of potential pairings of users that have a common second level connection to then filter the candidate pair(s) that are compatible with the user based on the constraints of the user's preferences (e.g., other users that have similar personality characteristics, have particular skills, live within a predefined location, etc.). In one example, communication process 10 generates the candidate pair using a weighted compatibility score, where multiple weights are applied to particular elements of compatibility. For instance, suppose a user (e.g., user 302) is using social network to enter a meaningful relationship. In this example, user 302 provides a ranking of personal characteristics desired in the other user. Communication process 10 converts this ranking to weights to apply to a compatibility score. Communication process 10 generates the weighted compatibility score for each user. The weighted compatibility score of each user in the potential pairings of users is compared to one another relative to a predefined threshold. For example, the predefined threshold may be user-defined or a default threshold. Referring again to the example of FIG. 3, communication process 10 compares compatibility scores between users 302 and 306; users 302 and 308; and users 302 and 310. In this example, communication process 10 generates two candidate pairs of users: users 302 and 306, and users 302 and 308 as the compatibility scores of users 302 and 312 were below the predefined threshold. While this example includes two candidate pairs of users, it will be appreciated that this is for example purposes only and that any number of candidate pairs may be generated within the scope of the present disclosure.

In some implementations, generating 202 the candidate pair of users includes prompting 212 the common second level connection to select the respective second user. For example and as an alternative approach to generating 202 the candidate pair of users, communication process 10 prompts 212 a common second level connection to select a candidate match for a particular user. For instance, suppose user 302 generates a profile and uses social network 300 to enter a meaningful relationship. In this example, user 304 receives a notification that user 302 has joined social network 300. Accordingly, communication process 10 determines that user 304 is a common second level connection for user 302 and users 306, 308, and 312. In this example, communication process 10 provides a listing of each of users 306, 308, and 312 to prompt user 304 for a recommendation of a candidate match for user 302. In one example, communication process 10 provides the resulting compatibility score between the users. In another example, communication process 10 provides a summary of each user's profiles with visual annotations in a user interface displaying matching and/or contrasting characteristics. In this manner, communication process 10 can visually flag the characteristics that are most similar (e.g., shown in green highlighting) and/or the characteristics that are most dissimilar (e.g., shown in red highlighting). In response to processing a selection of a candidate user from common second level connection user 304, communication process 10 provides a notification to user 302 of a recommendation from user 304 of a candidate user. In this example and as will described in greater detail below, communication process 10 provides a common second level connection with the ability to proactively enable electronic communication between particular users.

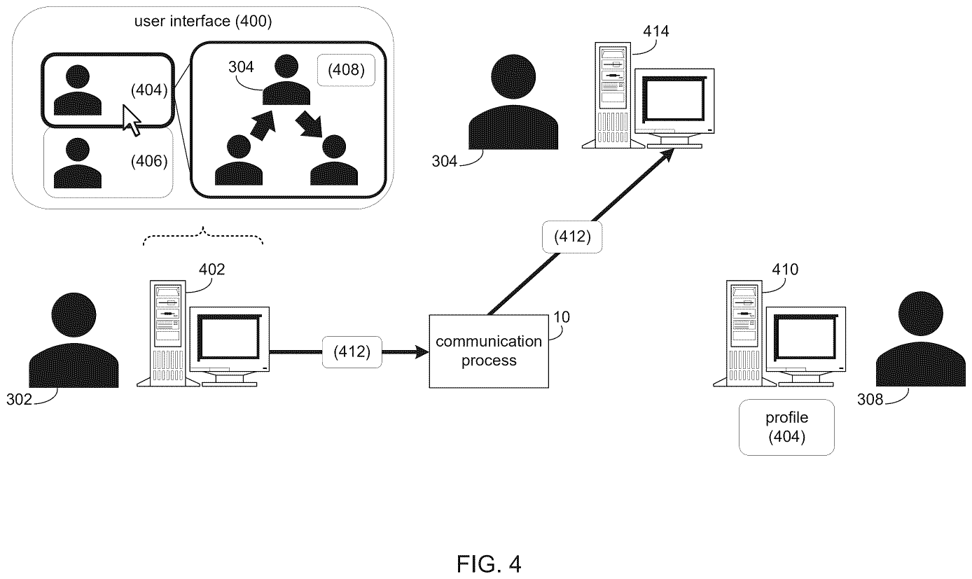

In some implementations, generating 202 the candidate pair of users includes providing 214 an indication of the respective second user and the common second level connection to the first computing device associated with the first user. Referring also to FIG. 4, communication process 10 displays profiles of suitable candidates in a user interface (e.g., user interface 400) on a computing device associated with a user (e.g., first computing device 402 associated with user 302). In this example, communication process 10 displays profiles 404, 406 concerning candidate users from the candidate pairs generated by communication process 10. Upon selection of a particular second user (e.g., profile 404 of user 308), communication process 10 displays the common second level connection for the selected candidate user (e.g., common second level 304).

In some implementations and to incentivize thoughtful connections while increasing user trust, each common second level connection is assigned a reputation score based on their success rate in facilitating actual connections between matched users. This score is visible to users when selecting a candidate user (e.g., in user interface 400), encouraging common second level connections to make high-quality recommendations and enhancing communication process 10's social dynamics. In some implementations, communication process 10 generates a reputation score as a percentage of successful connections (confirmed by both parties) relative to total number of direct electronic communications enabled by the common second level connection. Communication process 10 displays the reputation score when users view the common second level connection corresponding to a selected candidate user. In some implementations, reputation scores update dynamically as connections are verified.

In some implementations, communication process 10 processes a selection of a respective second user (e.g., user 308) by user 302 selecting option 408 displayed within user interface 400. As will be discussed in greater detail below, communication process 10 prevents first computing device 402 of user 302 from being able to make direct electronic communication with computing device 410 of user 308. Accordingly, in response to processing option 408, communication process 10 generates a request for user 304 to selectively enable direct electronic communication between prevents first computing device 402 of user 302 and computing device 410 of user 308.

In some implementations, communication process 10 processes 204 a request packet from a first computing device associated with the first user including a request for the common second level connection to enable the direct electronic communication between the first computing device associated with the first user and a computing device associated with the respective second user. For example and in response to user 302 selecting option 408 in user interface 400, communication process 10 generates a request packet (e.g., request packet 412) that includes a request for common second level connection (e.g., user 304) to enable direct electronic communication between first computing device 402 of user 302 and computing device 410 of user 308. In some implementations, request packet 412 is a formatted unit of data carried by a packet-switched network between computing devices and communication process 10. In the context of networking, request packet 412 is used to transmit request information across networks, such as the Internet or local area networks (LANs) between computing devices of users and a common second level connection. In some implementations, communication process 10 generates request packet 412 with a header (e.g., source and destination address information, protocol information, a packet number, and error detection coding); a payload including the request for the common second level connection to enable the direct electronic communication between the first computing device and the computing device of the other user; and/or a footer (e.g., error-checking data).

In some implementations, communication process 10 provides 206 the request packet to a computing device associated with the common second level connection. For example, and as shown in FIG. 4, communication process 10 provides request packet 412 from first computing device 402 to computing device 414 associated with user 304 (the common second level connection between user 302 and user 308).

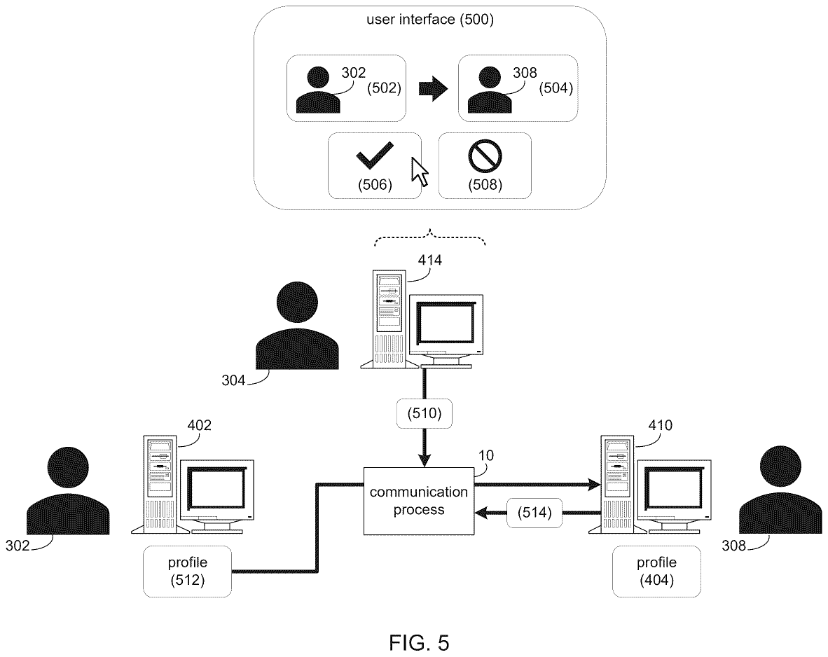

In some implementations, communication process 10 selectively enables 208 the direct electronic communication between the first computing device and the computing device associated with the respective second user in response to processing the request packet at the computing device associated with the common second level connection. Referring also to FIG. 5, communication process 10 provides a user interface (e.g., user interface 500) to the common second level connection (e.g., user 304) for user 304 to determine whether or not to enable the direct electronic communications between the request user (e.g., user 302) and the other user of the candidate pair (e.g., user 308). In the example of FIG. 5, communication process 10 generates and displays user interface 500 with information of the requesting user (e.g., information 502 of user 302) and information of the other user of the candidate pair (e.g., information 504 of user 308). In some implementation, communication process 10 provides information 502 and information 504 with results of the compatibility score comparison. In response to providing information 502 and information 504, communication process 10 prompts user 304 to enable (e.g., enable selection 506) or to prevent (e.g., prevent selection 508) direct electronic communication between first computing device 402 of user 302 and computing device 410 of user 308. As will be discussed in greater detail below, communication process 10 receives and processes either a direct electronic communication enablement packet or a direct electronic communication rejection packet (e.g., packet 510) from computing device 414.

In some implementations, selectively enabling 208 the direct electronic communication includes enabling 216 the direct electronic communication in response to receiving a direct electronic communication enablement packet from the computing device associated with the common second level connection that is configured to enable to the direct electronic communication between the first computing device associated with the first user and the computing device associated with the respective second user. For example, when the common second level connection determines that user 302 and user 308 will be a good match, communication process 10 receives a direct electronic communication enablement packet (e.g., packet 510) from computing device 414 indicating that the common second level connection recommends and enables the direct electronic communication between first computing device 402 and computing device 410. In one example, processing the direct electronic communication enablement packet (e.g., packet 510) includes providing the second user (e.g., user 308) with profile information (e.g., profile 512 of user 302) from the requesting user (e.g., user 302) to obtain a direct electronic communication enablement packet (e.g., packet 514) from user 308. If user 308 would like to enable direct electronic communication between user 308 and user 302, computing device 410 provides packet 514 to communication process 10. In this manner, packet 514 indicates that user 308 is interested in direct electronic communication with the requesting user (e.g., user 302). In another example, communication process 10 may process a direct electronic communication rejection packet (e.g., packet 514) from computing device 410. In this example and in response to processing direct electronic communication rejection packet 514, communication process 10 indicates that user 302's request cannot be granted.

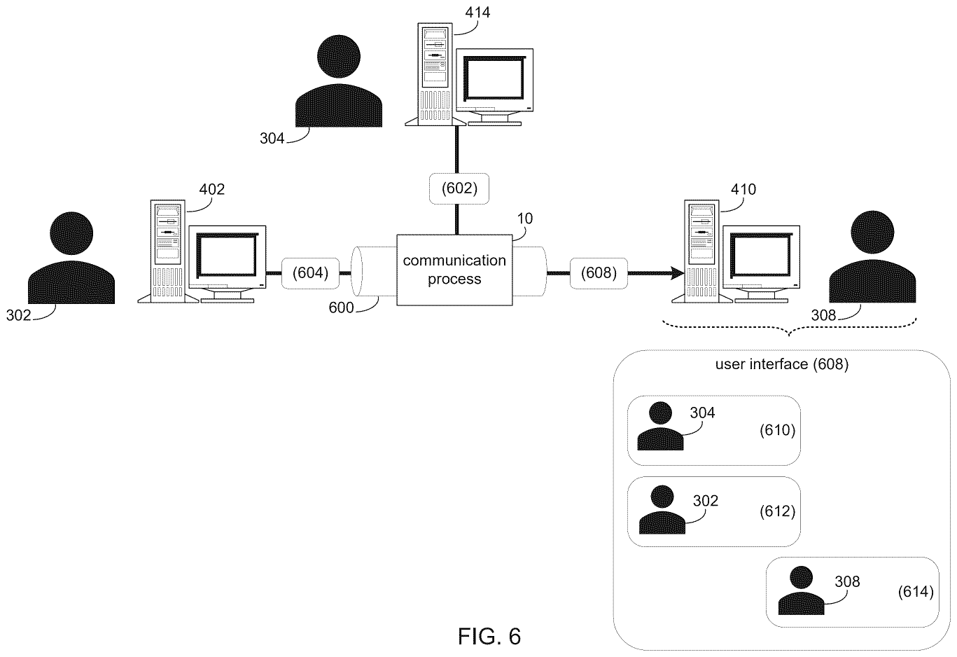

In some implementations, communication process 10 establishes 218 the direct electronic communication between the first computing device associated with the first user, the computing device associated with the respective second user, and the computing device associated with the common second level connection. Referring also to FIG. 6, if both parties are interested, the common second level connection can enable direct electronic communication between the candidate pair such that communication process 10 establishes a direct electronic communication (e.g., direct electronic communication 600) that allows communication packets 602, 604, and/or 606 to pass between first computing device 402, computing device 410, and/or computing device 414. In one example, direct electronic communication 600 includes a communication medium where users 302, 304, and 308 may communicate. For example, communication process 10 may enable user 304 to set up a group chat where the requesting user (e.g., user 302) and the candidate user (e.g., user 308) can be introduced.

In some implementations and to make introductions more meaningful and personalized, communication process 10 may prompt the common second level connection to attach a note, select a conversation starter, and/or select shared interests for display to both users (e.g., “You both enjoy live music!”) when enabling direct electronic communication 600. In another example, communication process 10 enables direct electronic communication 600 between first computing device 402 and computing device 410 with a predefined message indicating that the common second level connection (e.g., user 304) enabled direct electronic communication 600 between the users. In one example, communication process 10 generates a user interface (e.g., user interface 608) as a messaging interface with direct electronic communications (e.g., messages 610, 612, 614) from user 302 using first computing device 402, user 304 using computing device 414, and user 308 using computing device 410. In this example, message 610 is processed from data packet 602 provided by computing device 414 from user 304 and includes an introduction of user 308 to user 302. Message 612 is processed from data packet 604 provided by computing device 402 from user 302 and message 614 is processed from data packet 608 provided by computing device 410 from user 308.

In some implementations, selectively enabling 208 the direct electronic communication includes preventing 220 the direct electronic communication in response to receiving a direct electronic communication rejection packet from the computing device associated with the common second level connection that is configured to prevent the direct electronic communication between the first computing device and the computing device associated with the respective second user. As discussed above, if either the common second level connection (e.g., user 304) or the candidate user (e.g., user 308) does not enable direct electronic communication 600, communication process 10 processes a direct electronic communication rejection packet from the computing device associated with the common second level connection or the computing device associated with the respective second user to reject the request from user 302. In some implementations, the reject may or may not be provided with an explanation.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit”, “module”, or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to limit the disclosure. As used herein, the singular forms “a”, “an” and “the” are intended to include the plural forms as well, unless the context clearly indicates otherwise. As used herein, the language “at least one of A and B” (and the like) as well as “at least one of A or B” (and the like) should be interpreted as covering only A, only B, or both A and B, unless the context clearly indicates otherwise. The language “one or more of A and B” (and the like) as well as “one or more of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
processing a social network of connections between a plurality of users, wherein the social network of connections includes a plurality of first level connections and a plurality of second level connections between the plurality of users;
generating a candidate pair of users with a common second level connection, wherein the candidate pair of users includes a first user and a respective second user;
processing a request packet from a first computing device including a request for the common second level connection to enable a direct electronic communication between the first computing device and a computing device associated with the respective second user;
providing the request packet to a computing device associated with the common second level connection; and
selectively enabling the direct electronic communication between the first computing device and the computing device associated with the respective second user in response to processing the request packet at the computing device associated with the common second level connection.

2. The computer-implemented method of claim 1, further comprising:
generating a profile for the first user within the social network of connections.

3. The computer-implemented method of claim 1, wherein generating the candidate pair of users includes prompting the common second level connection to select the respective second user.

4. The computer-implemented method of claim 1, wherein generating the candidate pair of users includes providing an indication of the respective second user and the common second level connection to the first computing device associated with the first user.

5. The computer implemented method of claim 1, wherein selectively enabling the direct electronic communication includes enabling the direct electronic communication in response to receiving a direct electronic communication enablement packet from the computing device associated with the common second level connection that is configured to enable to the direct electronic communication between the first computing device associated with the first user and the computing device associated with the respective second user.

6. The computer implemented method of claim 5, further comprising:
establishing the direct electronic communication between the first computing device associated with the first user, the computing device associated with the respective second user, and the computing device associated with the common second level connection.

7. The computer implemented method of claim 1, wherein selectively enabling the direct electronic communication includes preventing the direct electronic communication in response to receiving a direct electronic communication rejection packet from the computing device associated with the common second level connection that is configured to prevent the direct electronic communication between the first computing device and the computing device associated with the respective second user.

8. A computer program product residing on a non-transitory computer readable medium having a plurality of instructions stored thereon which, when executed by a processor, cause the processor to perform operations comprising:
processing a social network of connections between a plurality of users, wherein the social network of connections includes a plurality of first level connections and a plurality of second level connections between the plurality of users;
generating a candidate pair of users with a common second level connection, wherein the candidate pair of users includes a first user and a respective second user;
processing a request packet from a first computing device including a request for the common second level connection to enable a direct electronic communication between the first computing device and a computing device associated with the respective second user;
providing the request packet to a computing device associated with the common second level connection; and
selectively enabling the direct electronic communication between the first computing device and the computing device associated with the respective second user in response to processing the request packet at the computing device associated with the common second level connection.

9. The computer program product of claim 8, wherein the operations further comprise:
generating a profile for the first user within the social network of connections.

10. The computer program product of claim 8, wherein generating the candidate pair of users includes prompting the common second level connection to select the respective second user.

11. The computer program product of claim 8, wherein generating the candidate pair of users includes providing an indication of the respective second user and the common second level connection to the first computing device associated with the first user.

12. The computer program product of claim 8, wherein selectively enabling the direct electronic communication includes enabling the direct electronic communication in response to receiving a direct electronic communication enablement packet from the computing device associated with the common second level connection that is configured to enable to the direct electronic communication between the first computing device associated with the first user and the computing device associated with the respective second user.

13. The computer program product of claim 12, wherein the operations further comprise:
establishing the direct electronic communication between the first computing device associated with the first user, the computing device associated with the respective second user, and the computing device associated with the common second level connection.

14. The computer program product of claim 8, wherein selectively enabling the direct electronic communication includes preventing the direct electronic communication in response to receiving a direct electronic communication rejection packet from the computing device associated with the common second level connection that is configured to prevent the direct electronic communication between the first computing device and the computing device associated with the respective second user.

15. A computing system comprising:
a memory; and
a processor configured to:
process a social network of connections between a plurality of users, wherein the social network of connections includes a plurality of first level connections and a plurality of second level connections between the plurality of users;
generate a candidate pair of users with a common second level connection, wherein the candidate pair of users includes a first user and a respective second user;
process a request packet from a first computing device including a request for the common second level connection to enable a direct electronic communication between the first computing device and a computing device associated with the respective second user;
provide the request packet to a computing device associated with the common second level connection; and
selectively enable the direct electronic communication between the first computing device and the computing device associated with the respective second user in response to processing the request packet at the computing device associated with the common second level connection.

16. The computing system of claim 15, wherein the processor is further configured to:
generate a profile for the first user within the social network of connections.

17. The computing system of claim 15, wherein generating the candidate pair of users includes prompting the common second level connection to select the respective second user.

18. The computing system of claim 15, wherein generating the candidate pair of users includes providing an indication of the respective second user and the common second level connection to the first computing device associated with the first user.

19. The computing system of claim 15, wherein selectively enabling the direct electronic communication includes enabling the direct electronic communication in response to receiving a direct electronic communication enablement packet from the computing device associated with the common second level connection that is configured to enable to the direct electronic communication between the first computing device associated with the first user and the computing device associated with the respective second user.

20. The computing system of claim 19, wherein the processor is further configured to:
establishing the direct electronic communication between the first computing device associated with the first user, the computing device associated with the respective second user, and the computing device associated with the common second level connection.
